(19) United States
(12) Patent Application Publication
(10) Pub. No.: US 2017/0057871 A1
(43) Pub. Date: Mar. 2, 2017

(54) CEMENT COMPOSITION FOR OIL AND GAS WELLS AND METHODS FOR USING THE SAME

(71) Applicant: Trican Well Service Ltd., Calgary (CA)

(72) Inventors: George Quercia BIANCHI, Calgary (CA); Karen LUKE, Calgary (CA)

(21) Appl. No.: 15/250,191

(22) Filed: Aug. 29, 2016

Related U.S. Application Data
(60) Provisional application No. 62/210,727, filed on Aug. 27, 2015.

(51) Int. Cl. C04B 24/32; C04B 28/04; E21B 33/138; C04B 24/14; C04B 24/38; C09K 8/467; C04B 24/28

(52) U.S. Cl. CPC C04B 24/32; C09K 8/467; C04B 28/04; C04B 24/287; C04B 24/283; C04B 24/14; C04B 24/383; E21B 33/138

(57) ABSTRACT

Cement composition suitable for cementing a well and method of preparing the cement composition are disclosed. The cement composition has cement, water and biodegradable polymeric elastomeric resin (BPR) as an additive. The BPR has a significantly lower elastic modulus than that of set cement. Other additives such as bond enhancer and/or foaming agent may also be used.

### FIELD OF THE DISCLOSURE

The present disclosure generally relates to cement compositions suitable for cementing a well and methods of preparing the cement compositions, and more particularly, to cement compositions with additives to improve mechanical properties of cement for the long term stability of the cement sheath and methods of preparing same for use in cementing oil and gas wells.

### BACKGROUND

Over the last two decades, there has been an increased focus on assessing the long-term stability of the cement sheath when exposed to changing wellbore stresses that can occur over the life time of the well. Although the cement sheath may initially fulfil its function in zonal isolation, changes in pressure conditions can result in induced stress on the cement sheath and loss of zonal isolation over time. Such changes in pressure conditions may be the result of, e.g., 1) pressure integrity testing, stimulation treatments, change in wellbore fluid, or reservoir depletion/injection, 2) temperature fluctuations on the casing from well production, steam injection, high temperature/high pressure (HT/HP) wells or, 3) in extreme cases geological shifts, creep, faulting, compaction over time.

Mechanical failure of the cement sheath itself leads to the formation of cracks, whereas debonding of the cement sheath from casing or formation leads to a micro-annulus. Traditionally, compressive strength has been used as an indicator of cement integrity. However, for long term integrity where the cement sheath is subjected to large changes in stress, the material/mechanical properties, such as tensile strength, Young's modulus, Poisson's ratio, unconfined and confined tri-axial measurements, are considered as key parameters.

It is known to use different ground or particulate elastomeric and thermoplastic materials to improve the mechanical properties, e.g., decreasing Young's modulus and increasing ductility, of cement compositions. For example, improvement in the cement sheath mechanical properties has in general been achieved by addition of fibers to enhance tensile strength and by addition of elastomeric materials to improve on Young's modulus and Poisson's ratio. More recently, engineered modification of the cement calcium silicate hydrate (C-S-H) matrix, as in addition of nano-materials, has been demonstrated to show improved mechanical properties and to provide resistance of the cement sheath to external stresses.

There remains a need for methods and compositions that improve cement mechanical properties. There is a move in the oil and gas industry towards improving the mechanical properties of cement for the long term stability of the cement sheath.

### SUMMARY

Herein, a cement composition suitable for cementing a well and a method of preparing the cement composition are disclosed. The cement composition comprises cement, water and biodegradable polymeric elastomeric resin (BPR) as an additive. Other additives such as bond enhancer and/or foaming agent may also be used.

According to one aspect of this disclosure, there is provided a mixture for cementing a wellbore. The mixture comprises: cement; and a biodegradable polymeric elastomeric resin (BPR) having a significantly lower elastic modulus than that of set cement.

In some embodiments, the BPR comprises: a starch component, a thermoplastic resin component; and a protein component; wherein the starch component, the thermoplastic resin component and the protein component are melted and mixed together to form the BPR.

In some embodiments, the BPR comprises: about 20 wt. % (weight percentage) to about 60 wt. % of the starch component; about 40 wt. % to about 80 wt. % of the thermoplastic resin component; about 0.5 wt. % to about 2 wt. % of the protein component; and 0 to about 30 wt. % of a plasticizer/dispersant component. In other words, the plasticizer/dispersant component may or may not be used in various embodiments. If the plasticizer/dispersant component is used, it may be added for up to about 30 wt. %.

In some embodiments, the starch component, the thermoplastic resin component, the protein component and the plasticizer/dispersant component are melted and mixed together to form the BPR.

In some embodiments, the plasticizer/dispersant component is a citric acid ester.

In some embodiments, the plasticizer/dispersant component is a non-citric acid based dispersant.

In some embodiments, the thermoplastic resin component is a polyester polyurethane resin, a polyester polyamide resin, or a polyether polyester resin.

In some embodiments, the protein component is albumin.

In some embodiments, the BPR is in a dry form.

In some embodiments, the mixture comprises about 1% by weight of cement (bwoc) to about 10% bwoc BPR.

In some embodiments, the mixture comprises about 3% bwoc to about 7% bwoc BPR.

In some embodiments, the mixture comprises about 5% bwoc BPR.

According to one aspect of this disclosure, there is provided a slurry for cementing a wellbore. The slurry comprises: water; and the above described mixture.

According to one aspect of this disclosure, there is provided a method for forming a wellbore cementing composition. The method comprises: combining water, cement and a biodegradable polymeric elastomeric resin (BPR) having a significantly lower elastic modulus than that of set cement.

In various embodiments, the BPR may be the BPR described above. For example, in some embodiments, the BPR comprises: a starch component, a thermoplastic resin component; and a protein component; wherein the starch component, the thermoplastic resin component and the protein component are melted and mixed together to form the BPR.

In some embodiments, the BPR comprises: about 20 wt. % to about 60 wt. % of the starch component; about 40 wt. % to about 80 wt. % of the thermoplastic resin component; about 0.5 wt. % to about 2 wt. % of the protein component; and

0 to about 30 wt. % of a plasticizer/dispersant component.

In some embodiments, said combining cement, water and the BPR comprises: combining cement, water and about 1% bwoc to about 10% bwoc BPR.

In some embodiments, said combining cement, water and the BPR comprises: combining cement, water and about 3% bwoc to about 7% bwoc BPR.

In some embodiments, said combining cement, water and the BPR comprises: combining cement, water and about 5% bwoc BPR.

In some embodiments, said combining cement, water and the BPR comprises: mixing the cement and the BPR to form a first mixture; and mixing the first mixture with the water.

According to one aspect of this disclosure, there is provided a method for cementing a wellbore. The method comprises: combining water, cement and a biodegradable polymeric elastomeric resin (BPR) comprising a starch component, a thermoplastic resin component and a protein component, wherein the starch component, the thermoplastic resin component and the protein component are melted and mixed together to form the BPR; and injecting the cement slurry into the wellbore.

In various embodiments, the BPR may be the BPR described above, and said combining cement, water and the BPR is as described above. For example, in some embodiments, said combining cement, water and the BPR comprises: combining cement, water and about 5% bwoc BPR.

### BRIEF DESCRIPTION OF THE DRAWINGS

FIG. 1 is a plot of the stress-strain (deviator stress vs axial strain) behavior of cement samples according to the disclosure herein, showing the differences in plastic strain (PD);

FIG. 2 is an SEM image at the 300 μm magnification level of a non-biodegradable polymeric elastomeric resin (TR) made from automotive recycled tires;

FIG. 3 shows an SEM image at the 200 μm magnification level of the morphological features of ground and angular particles of TR;

FIG. 4 is an SEM image at the 1 mm magnification level of the biodegradable polymeric elastomeric resin (BPR-1) disclosed herein;

FIG. 5 shows an SEM image at the 500 μm magnification level of the morphological features of ground and irregular particles of BPR-1;

FIG. 6 is an SEM image at the 1 mm magnification level of a cement blend containing 5% by weight of cement (bwoc) of the non-biodegradable polymeric elastomeric resin (TR) made from automotive recycled tires, showing the TR particle distribution in the cement matrix;

FIG. 7 is an SEM image at the 200 μm magnification level of a cement blend containing 5% bwoc of the non-biodegradable polymeric elastomeric resin (TR) made from automotive recycled tires, showing the angular morphology and separation between the rubber particles and cement matrix;

FIG. 8 is an SEM image at the 300 μm magnification level of a cement blend containing 5% bwoc of the biodegradable polymeric elastomeric resin (BPR-1) disclosed herein, showing the BPR-1 particle distribution in the cement matrix;

FIG. 9 is an SEM image at the 1 mm magnification level of a cement blend containing 5% bwoc of the biodegradable polymeric elastomeric resin (BPR-2) of the disclosure herein, showing the BPR-2 particle distribution in the cement matrix;

FIG. 10 is an SEM image at the 1 mm magnification level of a cement blend containing 5% bwoc of the biodegradable polymeric elastomeric resin (BPR-3) disclosed herein, showing the BPR-3 particle distribution in the cement matrix;

FIG. 11 is an SEM image at the 400 μm magnification level of a cement blend containing 5% bwoc of the biodegradable polymeric elastomeric resin (BPR-1) disclosed herein, showing the interparticle transition zone (ITZ) between the BPR-1 particle BPR and the cement matrix, and showing the white precipitates P and irregular interphase;

FIG. 12 is an SEM image at the 100 μm magnification level of a cement blend containing 5% bwoc of the biodegradable polymeric elastomeric resin (BPR-2) disclosed herein, showing the smooth and densified ITZ between the BPR-2 particle and the cement matrix;

FIG. 13 is an SEM image at the 100 μm magnification level of a cement blend containing 5% bwoc of the biodegradable polymeric elastomeric resin (BPR-2) disclosed herein, showing portlandite hexagonal plates precipitated between BPR-2 particles and a densified ITZ;

FIG. 14 is an X-ray characteristic florescence emission of the white precipitates shown in FIGS. 13 and 15.

FIG. 15 is an SEM image at the 50 μm magnification level of a cement blend containing 5% bwoc of the biodegradable polymeric elastomeric resin (BPR-3) disclosed herein, showing Ca—O—C rich precipitates around BPR-3 particles and a densified ITZ; and

FIG. 16 is an SEM image at the 50 μm magnification level of a cement blend containing 5% bwoc of the biodegradable polymeric elastomeric resin (BPR-3) disclosed herein, showing Ca—O—C rich precipitates around BPR-3 particles and a densified ITZ.

### DETAILED DESCRIPTION

Embodiments herein disclose cement compositions with a biodegradable polymeric elastomeric resin (BPR) as additive thereto for enhancing the mechanical properties of cement, and methods for using same. The BPR disclosed herein improves the mechanical properties of cement for the long term stability of the cement sheath. The so-obtained cement system exhibits better mechanical properties than conventional cement systems.

The composition and method disclosed herein may also be applicable in self-compacting concrete and special high-performance concrete for structural applications.

Herein, each embodiment results in a cement slurry generally comprising a cement, water and the additive which, when set, forms a cement sheath with enhanced mechanical properties compared to conventional cement sheath.

Any cement suitable for subterranean cementing can be used in the compositions and methods disclosed herein. For example, the cement may be a hydraulic cement, such as Portland cement, pozzolanic cements, gypsum cements, soil cements, silica cements, high alkalinity cements, or a combination thereof. In some embodiments, the cement can be any one or combination of class A, B, C, G, and H Portland cements as defined in API Specification 10A, entitled “Specification for Cements and Materials for Well Cementing”, twenty-fourth edition, published by the American Petroleum Institute (API) of Washington, D.C., USA, in December, 2010, the content of which is incorporated herein by reference in its entirety, or as defined in any other existing versions thereof.

In other embodiments, the cement can be a type of cement as defined in ISO 10426-1:2009, entitled “Petroleum and natural gas industries—Cements and materials for well cementing—Part 1: Specification,” developed by the International Organization for Standardization (ISO) of Geneva, Switzerland, the content of which is incorporated herein by reference in its entirety, or as defined in any other existing versions thereof.

In yet other embodiments, the cement can be Type I, IA, II(MH), II(MH)A, III, IIIA, IV, and V Portland cements as defined in ASTM C150/C150M -12, entitled “Standard Specification for Portland Cement”, published by ASTM International of West Conshohocken, Pennsylvania, USA, in April, 2012, the content of which is incorporated herein by reference in its entirety, or as defined in any other existing versions thereof.

The water used for making the cement slurry can be any suitable type of water conventionally used for making cement slurry for subterranean cementing, such as low mineral water, including tap water. However, those skilled in the art will appreciate that, other water, such as brine water, seawater or the like, can also be used.

In embodiments, The BPR suitable for improving cement mechanical properties in a downhole environment is a biodegradable polymer that has a significantly lower elastic modulus than that of set cement. In embodiments, the BPR may be a biodegradable resin and/or a biodegradable elastomer.

In some embodiments, the BPR has an elastic modulus about, or lower than, 1/100 of that of set cement. In some other embodiments, the BPR has an elastic modulus about, or lower than, 1/500 of that of set cement.

By using methods disclosed herein, the BPR, as a “very elastic” material compared to cement, is added to the matrix of the “inelastic” set cement to increase the elasticity thereof.

In embodiments, the BPR suitable for improving cement mechanical properties in a downhole environment may comprise: about 20 wt. % (weight percentage) to about 60 wt. % of a starch component; about 40 wt. % to about 80 wt. % of a thermoplastic resin component; about 0.5 wt. % to about 2 wt. % of a protein component; and 0 to about 30 wt. % of a plasticizer/dispersant.

In other words, in some embodiments, no plasticizer/dispersant is used; in some other embodiments, up to 30 wt. % plasticizer/dispersant may be used.

The starch component of the BPR may comprise a starch obtained from plant sources, such as cereal plants (e.g., corn, wheat, rice, barley, triticale and sorghum), tubers (e.g., potato and cassava), legumes (e.g., peas, soybeans, and beans), or derived from other non-food cellulosic materials and biomass. The starch component may comprise entirely unmodified starch, or it can be starch that has been mixed, modified, or complexed with other materials to improve the mechanical properties thereof.

The thermoplastic resin component is an elastomeric synthetic polymeric resin that tends to soften when heated and solidified when cooled, for example, a polyester polyurethane resin, a polyester polyamide resin, or a polyether polyester resin. In embodiments, the thermoplastic resin component comprises one or more members selected from the group consisting of thermoplastic polyurethane resins (TPU), copolyester elastomers such as polyether polyester (COPE) resins and polyether polyamide (COPA) resins, and combinations thereof. In embodiments, the thermoplastic resin component includes TPU alone or in combination with at least one of COPA and COPE.

The protein component of the BPR may be a water-soluble and heat-denaturable protein. As used herein, the term “water soluble protein” refers to natural or modified proteins that have solubility in water of at least 1 mg/mL at 25° C., and more preferably at least 10 mg/mL at 25° C. In embodiments, the water-soluble protein is not glycosylated, that is, does not contain sugar chains. The water-soluble protein may be albumin. The albumin may be derived from any source including eggs and bovine serum.

The plasticizer/dispersant is a particle dispersant and may be used (i.e., being a non-zero percentage in the BPR) for improving the softness of the BPR and/or the dispersion of the BPR in cement. The plasticizer/dispersant may be any suitable material known to improve the softness of a polymeric resin material, for example, citric acid ester such as acetyltributyl citrate, or non-citric acid based compounds such as glycerol. Exemplary plasticizers include various poloyls, ethers, thioethers, inorganic and organic esters, acetals, and derivatives thereof. Preferred plasticizers include organic acid-derived plasticizers, especially organic acid ester plasticizers. Exemplary organic acid-derived plasticizers include citric acid-derived plasticizers, such as a citric acid ester plasticizer, adipic acid derivatives such as tridecyl adipate, and benzoic acid derivatives such as isodecyl benzoate.

The components (1) to (4) of the BPR are blended together using a suitable mixing apparatus, under conditions sufficient to form a resin melt. For example, the well-known extrusion process may be used to melt and mix the components (1) to (4) at about 250° F. to 330° F. (i.e., about 121° C. to about 166° C.), and then extrude the mixture as a single polymer resin.

The precise processing conditions employed in the production of the BPR may depend somewhat on the equipment employed (e.g., extruder configuration, barrel length, screw configuration, screw speed), however, generally the temperature of the material within the extruder is maintained below 330° F. The mixing process generally does not initiate or promote chemical reactions between the various components, although it is possible for the individual components themselves to be chemically altered, such as complete or partial denaturation of the protein component. Thus, the resulting BPR is a melt-blended resin.

In various embodiments, the combination of components in the BPR and the corresponding process for making it may be customized to adjust properties of the BPR for enhancing the mechanical properties of the cement. For example, the melt blends disclosed in U.S. Pat. No. 9,023,918, incorporated by reference herein in its entirety, can be used as the additive to cement for enhancing the mechanical properties thereof.

In some alternative embodiments, other additives such as bond enhancers may also be added to cement to further modify cement properties. In yet another embodiment, the BPR can be combined with a foaming agent to form a biodegradable foam product the can be advantageous in lightweight cement systems.

The BPRs disclosed herein may be provided as a dry additive, alone or mixed with dry-form cement. In use, the BPR additive, cement and water are mixed to uniformly distribute the BPR particles in the cement slurry and subsequently the set cement.

For example, the BPR additive may be mixed with dry-form cement, and then mixed with water to form a cement slurry having the BPRs uniformly distributed therein, for cementing a wellbore. Alternatively, the BPR additive may be directly added to a cement slurry and mixed therewith to form a slurry having the BPRs uniformly distributed therein, for cementing a wellbore.

In some embodiments, about 1% by weight of cement (bwoc) to about 10% bwoc BPR may be used, i.e., mixed with cement (or cement and water). In some other embodiments, about 3% bwoc to about 7% bwoc BPR may be used. In yet some other embodiments, about 4% bwoc to about 6% bwoc BPR may be used. In still some other embodiments, about 5% bwoc BPR may be used.

The BPR additive improves the mechanical properties of cement, such as Poisson's ratio, Young's modulus, unconfined and confined tri-axial measurements. Compared to a conventional cement sheath without the BPR additive, the BPR enhanced cement sheath may exhibit a lower Young's modulus, a higher Poisson's ratio, and better tensile and compressive strength, which provide resilience to withstand the stresses encountered in the cement sheath during the lifetime of a well. In addition, the BPR enhanced cement sheath, when cured at downhole temperature and pressures, may exhibit a lower ratio of compressive strength to tensile strength (CS/TS), compared to conventional cement compositions.

A further advantage of BPR enhanced cement compositions may be that the polymeric resin is biodegradable, and the BPR enhanced cement compositions can be used in environments where biodegradable material is preferred.

### EXAMPLES

The following examples further illustrate the cement compositions disclosed herein. In these examples, a plurality of 600 mL cement slurry samples are prepared. Each sample is prepared by mixing API Class G or Class C cement with water according to API Recommended Practice 10B-2 (API RP 10B-2, formerly API RP 10B), entitled “Recommended Practice for Testing Well Cements,” SECOND EDITION, published by API in April 2013.

Three types of BPRs (denoted as BPR-1, BPR-2 and BPR-3) and one prior-art, non-biodegradable elastomeric additive (recycled automotive rubber, denoted as TR) are also added to some samples as described below.

The three BPRs, BPR-1, BPR-2 and BPR-3, are Terratek® GDH-B1IM, RD0722315, and Terratek® GDH-B1 FA, respectively, manufactured by Green Dot Bioplastics of Cottonwood Falls, KS, U.S.A. BPR-1 comprises 40 wt. % starch, 29.25 wt. % polyurethane, 1.5 wt. % albumin and 29.25 wt. % acetyltributyl citrate (a citrate based plasticizer). BPR-2 comprises 40 wt. % starch, 58.5 wt. % polyurethane and 1.5 wt. % albumin. BPR-2 does not comprise any plasticizer. BPR-3 is similar to BPR-1 but comprises glycerol as plasticizer, instead of acetyltributyl citrate. Tables 1-1 and 1-2 list some properties of BPR-1 and BPR-3, respectively, according to Green Dot Bioplastics. Table 1-3 lists the characteristics of the polymeric elastomeric additives used in the examples.

TABLE 1-1
Properties of BPR-1 (Terratek ® GDH-B1IM)

| Property | Test Method | Value | |
|---|---|---|---|
| Specific Gravity | ASTM D792 | 1.211 | |
| Hardness | ASTM D2240 | 83 Shore A | |
| Tensile | ASTM D638 | 1,495 | psi |
| | | (10.3 | MPa)) |
| Elastic Modulus | ASTM D638 | 3,210 | psi |
| | | (22.1 | MPa) |

| | | |
|---|---|---|
| Elongation at Break | ASTM D638 | 766% |
| Melt Flow | | 38.2 g/10 min |

TABLE 1-2
Properties of BPR-3 (Terratek ® GDH-B1FA)

| Property | Test Method | Value | |
|---|---|---|---|
| Specific Gravity | ISO 1183-1 | 1.23 | |
| Hardness | ISO 868 | 74 Shore A | |
| Tensile Strength | ISO 37 | 9.4 | MPa |
| (Ultimate) | | (1,363 | psi) |
| Elastic Modulus | ISO 37 | 4.4 | MPa |
| | | (638 | psi) |
| Elongation at Break | ISO 37 | >600% | |
| Tear Strength | ISO 34-1 | 57 | N/mm |

| | | |
|---|---|---|
| MFI @ 190° C./2.2 kg | ISO 1133 | 57 g/10 min |
| Compress Set, | ISO 815/ | 33% |
| 22 hrs @ 23° C. | ASTM D395(B) | |
| Compress Set, | ISO 815/ | 82% |
| 22 hrs @ 70° C. | ASTM D395(B) | |
| Melt Flow | | 29.1 g/10 min |

TABLE 1-3
Characteristics of polymeric elastomeric additives used

| | Particle size | |
|---|---|---|
| | (micron) | Density |
| Additive | (100% passing) | (g/cc) |
| TR | 125 | 1.14 |
| BPR-1 | 500 | 1.23 |
| BPR-2 | 500 | 1.23 |
| BPR-3 | 500 | 1.23 |

The API RP 10B-2 defines a standard procedure for weighing, mixing and blending a cement sample to form a cement slurry in a lab environment using a sample size reasonable for lab testing, to simulate the amount and rate of shear during mixing in the field, wherein the rate of shear affects cement performance. Further, API RP 10B-2 ensures consistency from lab to lab.

Essentially, API RP 10B-2 requires that the cement is added to the water instead of adding the water to the cement. API RP 10B-2 defines that the cement and dry additives are weighed, dry blended to give a uniform blend and added to the required amount of water at a uniform rate in no more than 15 seconds to make a slurry volume of approximately 600 mL in a mixing device, such as a Waring blender, at a speed of 4000 revolutions per minute (rpm). The slurry is then mixed an additional 35 seconds at 12,000 rpm.

According to API RP 10B-2, the 4000 rpm rotation during addition of the cement powder into the water is the highest shear that allows the cement and water to mix together. After the cement has mixed into the water, the 35-second 12,000 rpm rotation, together with the previous 15-second 4000 rpm rotation, results in a shear rate equivalent to that typically obtained in the field.

According to API RP 10B-2, cement mixing is conducted at temperatures representative of the above-ground temperature in the field, or at 23° C.±1° C. if the above-ground temperature in the field is unknown. Practically, cement mixing is conducted at room temperature in most cases. After cement mixing, testing can be conducted at various temperatures and pressures in accordance with test design and expected well conditions.

### Example 1

### Thickening Time Measurement at 50° C.

In this example, the effect of BPR additives on thickening time is compared. Seven samples of cement slurries were obtained according to API RP 10B-2 by first preparing seven 600 mL slurries of API Class G cement with or without the addition of different types of BPR or TR, as described below. Each sample was then placed into a consistometer cell and heated up to 50° C. The thickening time is measured according to API RP 10B-2, Section 9 “Well-Simulation Thickening Time Tests”.

The first sample (1A) was a neat API Class G cement with 0.1% bwoc of anti-settling acrylate-based copolymer viscosifier and 0.2% bwoc of a glycol polymer antifoam agent (PG-A), which were then mixed with water according to API RP 10B-2 to obtain a slurry with a density of 1.901 g/cm³.

The second sample (1 B) was prepared by first dry blending API Class G cement with 5% bwoc TR and 0.2% bwoc of a glycol polymer antifoam agent (PG-A), which were then mixed with water according to API RP 10B-2 to obtain a slurry with a density of 1.860 g/cm³.

The third sample (1 C) was prepared by first dry blending API Class G cement with 5% bwoc BPR-1 and 0.2% bwoc of a glycol polymer antifoam agent (PG-A), which were then mixed with water according to API RP 10B-2 to obtain a slurry with a density of 1.860 g/cm³.

The fourth sample (1 D) was prepared by first dry blending API Class G cement with 2% bwoc BPR-2 and 0.2% bwoc of a glycol polymer antifoam agent (PG-A), which were then mixed with water according to API RP 10B-2 to obtain a slurry with a density of 1.901 g/cm³.

The fifth sample (1E) was prepared by first dry blending API Class G cement with 5% bwoc BPR-2 and 0.2% bwoc of a glycol polymer antifoam agent (PG-A), which were then mixed with water according to API RP 10B-2 to obtain a slurry with a density of 1.860 g/cm³.

The sixth sample (1 F) was prepared by first dry blending API Class G cement with 2% bwoc BPR-3 and 0.2% bwoc of a glycol polymer antifoam agent (PG-A), which were then mixed with water according to API RP 10B-2 to obtain a slurry with a density of 1.901 g/cm³.

The seventh (1G) sample was prepared by first dry blending API Class G cement with 5% bwoc BPR-3 and 0.2% bwoc of a glycol polymer antifoam agent (PG-A), which were then mixed with water according to API RP 10B-2 to obtain a slurry with a density of 1.901 g/cm³.

Each of the samples was poured into a slurry cup assembly and placed into a test cell with pressure applied (40 MPa) and heated to 50° C. The slurry container was rotated at 150 RPM. The amount of torque the slurry exerts on an API-approved paddle is measured to determine the Bearden Unit of Consistency (Bc) of each sample. In this example, the thickening times to 40 Bc and 100 Bc are respectively recorded for each sample. Generally, cement slurry of 70 Bc or lower is considered as suitable for pumping into wellbores.

The test results are shown in Table 2, where “-” means that no additive was added. As can be seen, thickening time is retarded or accelerated compared to neat cement slurry (1A), depending of the type of biodegradable polymeric elastomeric resin added. This demonstrates that the biodegradable polymeric elastomeric resins can be tailored to have controlled retardation effects of cement consistency.

TABLE 2
Thickening Time Testing Results

| | | | | Thickening Time | | |
|---|---|---|---|---|---|---|
| | | | Temp | (Hours:minutes) | | |
| Slurry | Additive type | Viscosifier | (° C.) | 40Bc | 70Bc | 100Bc |
| 1A | — | 0.1% bwoc | 50 | 1:15 | 1:32 | 1:38 |
| 1B* | 5% bwoc TR | — | 50 | 0:55 | 1:07 | 1:12 |
| 1C | 5% bwoc | — | 50 | 5:58 | 6:21 | 6:58 |
| | BPR-1 | | | | | |
| 1D | 2% bwoc | — | 50 | 1:20 | 1:37 | 1:50 |
| | BPR-2 | | | | | |
| 1E | 5% bwoc | — | 50 | 1:03 | 1:30 | 1:35 |
| | BPR-2 | | | | | |
| 1F | 2% bwoc | — | 50 | 1:26 | 1:46 | 2:01 |
| | BPR-3 | | | | | |
| 1G | 5% bwoc | — | 50 | 1:20 | 1:35 | 1:43 |
| | BPR-3 | | | | | |

*Prior art.

### Example 2

### Thickening Time Measurement at 100° C.

Similar to the previous example, the effect of BPR additives on thickening time is compared at higher temperature. First five samples of cement slurries were obtained according to API RP 10B-2 by first preparing seven 600 mL slurries of API Class G cement with or without the addition of different types of BPR or TR, as described below. Each sample was then placed into a consistometer cell and heated up to 100° C. The thickening time is measured according to API RP 10B-2, Section 9 “Well-Simulation Thickening Time Tests”.

The first sample (2A) prepared was a neat API Class G cement with 0.1% bwoc of anti-settling acrylate-based copolymer viscosifier and 0.2% bwoc of a glycol polymer antifoam agent (PG-A), which were then mixed with water according to API RP 10B-2 to obtain a slurry with a density of 1.901 g/cm³.

The second sample (2B) was prepared by first dry blending API Class G cement with 2% bwoc TR and 0.2% bwoc of a glycol polymer antifoam agent (PG-A), which were then mixed with water according to API RP 10B-2 to obtain a slurry with a density of 1.901 g/cm³.

The third sample (2C) was prepared by first dry blending API Class G cement with 2% bwoc BPR-1 and 0.2% bwoc of a glycol polymer antifoam agent (PG-A), which were then mixed with water according to API RP 10B-2 to obtain a slurry with a density of 1.901 g/cm³.

The fourth sample (2D) was prepared by first dry blending API Class G cement with 5% bwoc TR and 0.2% bwoc of a glycol polymer antifoam agent (PG-A), which were then mixed with water according to API RP 10B-2 to obtain a slurry with a density of 1.860 g/cm³.

The fifth sample (2E) was prepared by first dry blending API Class G cement with 5% bwoc BPR-1 and 0.2% bwoc of a glycol polymer antifoam agent (PG-A), which were then mixed with water according to API RP 10B-2 to obtain a slurry with a density of 1.860 g/cm³.

Each of the samples was poured into a slurry cup assembly and placed into a test cell with pressure applied (70 MPa) and heated to 100° C. The slurry container was rotated at 150 RPM.

The test results are shown in Table 3, where “-” means that no additive was added. As can be seen, at 100° C. the thickening time is not affected by the addition of the biodegradable polymeric elastomeric resin (BRP-1), compared to neat cement slurry (2A) or by the addition of TR (2B, 2D). This implies that the thickening time can be controlled by the use of conventional retarders similar to neat Class G cement slurries.

TABLE 3
Thickening Time Testing Results

| | | | | Thickening Time | | |
|---|---|---|---|---|---|---|
| | | | Temp | (Hours:minutes) | | |
| Slurry | Additive type | Viscosifier | (° C.) | 40Bc | 70Bc | 100Bc |
| 2A | — | 0.1% bwoc | 100 | 0:51 | 0:57 | 0:59 |
| 2B* | 2% bwoc TR | — | 100 | 0:55 | 0:59 | 1:00 |
| 2C | 2% bwoc BPR-1 | — | 100 | 0:48 | 0:51 | 0:54 |
| 2D* | 5% bwoc TR | — | 100 | 0:50 | 0:53 | 0:55 |
| 2E | 5% bwoc BPR-1 | — | 100 | 0:53 | 0:55 | 0:56 |

*Prior art.

Additional thickening time tests were performed at 100° C. on three different cement slurries samples obtained according to API RP 10B-2 by preparing three 600 mL slurries of API Class C cement with additions of Fly-ash (FA) and silica fume (SF). Two of the slurries were formulated with different amounts of BPR-1, as described below. Each sample was then placed into a consistometer cell and heated up to 100° C. The thickening time is measured according to API RP 10B-2, Section 9 “Well-Simulation Thickening Time Tests”.

The first sample (3A) prepared was a dry mix of API Class C cement with 70% bwoc Fly-ash, 14% bwoc Silica fume and 0.2% bwoc of a glycol polymer antifoam agent (PG-A), which were then mixed with water according to API RP 10B-2 to obtain a slurry with a density of 1.550 g/cm³.

The second sample (3B) prepared was the same previously described dry mix (3A) of API Class C, fly-ash and silica fume with 2% bwoc of BPR-1, which were then mixed with water according to API RP 10B-2 to obtain a slurry with a density of 1.550 g/cm³.

The third sample (3C) prepared was the same previously described dry mix (3A) of API Class C, fly-ash and silica fume with 5% bwoc of BPR-1, which were then mixed with water according to API RP 10B-2 to obtain a slurry with a density of 1.550 g/cm³.

Each of the samples was poured into a slurry cup assembly and placed into a test cell with pressure applied (70 MPa) and heated to 100° C. The slurry container was rotated at 150 RPM.

The test results are shown in Table 4, where “-” means that no additive was added. As can be seen, at 100° C. the thickening time is affected by the addition of the biodegradable polymeric elastomeric resins type 1 (BRP-1) when compared to a blended cement slurry (Class C+FA+SF). This demonstrates that the biodegradable polymeric elastomeric resins can be tailored to have controlled retardation effects on blended cement consistency as well.

TABLE 4
Thickening Time Testing Results

| | | | | Thickening Time | | |
|---|---|---|---|---|---|---|
| | | | Temp | (Hours:minutes) | | |
| Slurry | Blend type | BPR-1 | (° C.) | 40Bc | 70Bc | 100Bc |
| 3A | Class C + FA + SF | — | 100 | 0:53 | 0:55 | 0:57 |
| 3B | Class C + FA + SF | 2% bwoc | 100 | 1:10 | 3:33 | 3:41 |
| | | BPR-1 | | | | |
| 3C | Class C + FA + SF | 5% bwoc | 100 | 1:43 | 3:35 | 3:44 |
| | | BPR-1 | | | | |

### Example 3

### Ultrasonic Compressive Strength Measurement

In this example, the effect of biodegradable polymeric elastomeric resins additives (BPR) or non-biodegradable elastomeric additives (TR) on ultrasonic compressive strength of set cement is compared. Fifteen samples of set cement, including samples 1A to 1G, 2A to 2E and 3A to 3E described in above examples 1 and 2, were prepared according to API RP 10B-2. The samples were then cured at 50 and 100° C. before measuring their compressive strength.

The test was conducted according to API RP 10B-2, Section 7 “Well-Simulation Compressive-strength Tests”. The test results are shown in Table 5, where “-” represents no BPR or TR being added. Table 5 shows, for each sample, the time in (hours: minutes) format for attaining 3.5 MPa compressive strength (the fifth column), and the compressive strength measurements after 8, 12, 24 and 48 hours, respectively (the sixth to ninth columns). As can be seen, the addition of biodegradable polymeric elastomeric resin additives decreases the evolution and final value of the ultrasonic compressive strength of cement Class G or blended cement, as compared to cement slurries without them. Regulatory authorities require that cement must reach a minimum compressive strength of 3.5 MPa across zones of interest within 48 hours. Table 5 shows that, except for blend 1C at 50° C., the biodegradable polymeric elastomeric resin blends meet the necessary requirement within 48 hours. Similar to the thickening time, the BPR can be tailored to modify the ultrasonic compressive strength evolution and ultimate value of cement slurries after 48 hours.

TABLE 5
Ultrasonic Compressive Strength Testing Results

| | | | Compressive Strength (MPa) | | | | |
|---|---|---|---|---|---|---|---|
| | | Temp | 3.5 | | | | |
| Slurry | Additive type | (° C.) | MPa | 8-h | 12-h | 24-h | 48-h |
| 1A | — | 50 | 4:12 | 9.7 | 13.4 | 19.5 | 23.6 |
| 1B* | 5% bwoc TR | 50 | 3:52 | 9.7 | 12.9 | 17.2 | 20.2 |
| 1C | 5% bwoc BPR-1 | 50 | >60 | — | — | — | — |
| 1D | 2% bwoc BPR-2 | 50 | 4:03 | 10.4 | 14.0 | 19.5 | 23.0 |
| 1E | 5% bwoc BPR-2 | 50 | 3:54 | 8.2 | 10.5 | 14.3 | 16.7 |
| 1F | 2% bwoc BPR-3 | 50 | 4:13 | 9.1 | 12.0 | 17.0 | 20.0 |
| 1G | 5% bwoc BPR-3 | 50 | 4:25 | 7.6 | 9.7 | 13.0 | 15.0 |
| 2A | — | 100 | 2:21 | 15.0 | 18.1 | 21.9 | 23.7 |
| 2B* | 2% bwoc TR | 100 | 2:30 | 12.1 | 14.5 | 17.6 | 19.2 |
| 2C | 2% bwoc BPR-1 | 100 | 6:12 | 6.0 | 8.8 | 11.9 | 13.7 |
| 2D* | 5% bwoc TR | 100 | 2:35 | 11.1 | 13.2 | 15.8 | 17.0 |
| 2E | 5% bwoc BPR-1 | 100 | 14:30 | 0.1 | 1.7 | 7.7 | 10.3 |
| 3A | Class C + FA + | 100 | 2:16 | 15.5 | 15.9 | 16.2 | 16.7 |
| | SF | | | | | | |
| 3B | 2% bwoc BPR-1 | 100 | 10:48 | 0.3 | 6.1 | 13.4 | 14.3 |
| 3C | 5% bwoc BPR-1 | 100 | 11:10 | 0.1 | 5.2 | 9.8 | 10.3 |

*Prior art.

### Example 4

### Tensile Strength Measurement

In this example, seven samples of set cement, including samples 1E, 1G and 2A to 2E as described above, were obtained according to API RP 10B-2 and slurries designs described on examples 1 and 2, by first preparing 600 mL slurries of API Class G cement with BPR additive or TR additive. After blending, the slurries were conditioned in an atmospheric consistometer for 20 min at 25 ° C. Slurries were then poured in two layers into the molds (dog-bone shaped) and tapped with a glass bar to remove any trapped air bubbles. The molds were placed in a pressurized chamber and cured for 6 days at 100° C. and 17.23 MPa of pressure. Ramp time from 25° C. to 100° C. was 60 minutes. After the initial curing the samples were left to cool-down to room temperature over a period of one day. All prepared samples (6 briquettes per slurry) were de-molded and tested at 7 days for their direct tensile strength following the modified procedure described in ASTM C307-08. An ADMET eXpert 2600 dual column table top universal tensile/compressive testing machine (MTestQuattro® control) was used in all experiments.

The test results are shown in Table 6, where “-” means that no additive was added. As can be seen, the tensile strength values varied depending of the BPR composition and type. Among the samples with BPR additives, Blends with 2% bwoc BPR-1 shows the highest tensile strength, and blends with BPR-2 and BPR-3 present the lowest tensile strength values. These results show that the use of BRP additives can be tailored to the desired level of tensile strength.

TABLE 6
Tensile strength Testing Results

| | | | Tensile | Tensile |
|---|---|---|---|---|
| | Additive | | strength | strength |
| Slurry | type | % bwoc | (Psi) | (MPa) |
| 2A | — | — | 508 | 3.50 |
| 2B | TR | 2 | 537 | 3.70 |
| 2C | BPR-1 | 2 | 522 | 3.60 |
| 2D | TR | 5 | 450 | 3.10 |
| 2E | BPR-1 | 5 | 479 | 3.30 |
| 1E | BPR-2 | 5 | 366 | 2.52 |
| 1G | BPR-3 | 5 | 323 | 2.23 |

### Example 5

### Rheology

In this example, the effect of BPR additives on the viscosity of cement slurry is assessed. Eight samples of cement slurries, including samples 1A, 1E, 1G, 2B, 2C, 2D, 2E and 3C as described above, were obtained according to API RP 10B-2. The test was conducted according to API RP 10B-2, Section 11 “Determination of Rheological Properties and Gel Strength Using a Rotational Viscometer” and Section 12 “Well-Simulation Slurry Stability Tests”. The test results are shown in Table 7, where “-” means that no BPR or TR was added.

As can be seen, the addition of BPR additives slightly affects the apparent viscosity of the slurry in comparison to the neat cement and decreases the yield value. Additionally, the blends containing BPR additives have better apparent viscosities and yield points than blends containing traditional polymeric elastomeric resins such as TR. Table 7 shows that the slurries with biodegradable polymeric elastomeric resins have good rheologies and can be pumped in oil and gas wells. Slurries are stable with virtually no free water or particle sedimentation.

TABLE 7
Rheology Testing Results

| | | | Rheology (Dial Reading) | | | | | | | |
|---|---|---|---|---|---|---|---|---|---|---|
| | Additive | % | 300 | 200 | 100 | 6 | 3 | PV | YP | |
| Slurry | type | bwoc | (rpm) | (rpm) | (rpm) | (rpm) | (rpm) | (mPa · s) | (Pa) | R² |
| 1A | — | — | 116 | 105 | 93 | 26 | 19 | 44 | 38 | 0.938 |
| 2B | TR | 2 | 91 | 76 | 60 | 21 | 13 | 50 | 22 | 0.996 |
| 2C | BPR-1 | 2 | 59 | 44 | 32 | 17 | 10 | 38 | 10 | 0.994 |
| 2D | TR | 5 | 124 | 103 | 80 | 24 | 17 | 72 | 27 | 0.994 |
| 2E | BPR-1 | 5 | 67 | 52 | 37 | 16 | 12 | 46 | 11 | 1.000 |
| 1E | BPR-2 | 5 | 91 | 78 | 61 | 24 | 17 | 51 | 21 | 0.987 |
| 1G | BPR-3 | 5 | 94 | 82 | 64 | 22 | 16 | 52 | 23 | 0.979 |
| 3C | — | — | 40 | 34 | 27 | 16 | 11 | 21 | 10 | 0.998 |

### Example 6

### Mechanical Properties Measurements—Tri-Axial Testing

The following series of tests were performed to evaluate the mechanical properties of cement compositions that comprise BPR additives and TR. In this example, the cement compositions comprising TR are used as reference materials.

Seven sample compositions, including samples 1E, 1G, and 2A to 2E as described above, were prepared according to API RP 10B-2. Tests were then performed to determine the compressive strength (UCS), Young's Modulus (YM), and Poisson's ratio (v) associated with each cement blend. Weight and mixing of cement slurry were according to API 10B-2. After mixing the prepared slurries were poured in a cup from the atmospheric consistometer and conditioned for 20 min at 25° C. After conditioning, the slurries were removed from the consistometer cup, agitated with a stick and casted into the prepared sedimentation test molds. At least two sedimentation test molds or “BP cell” (h=200 mm, φ=25.4 mm) with demolding agent were used to obtain two cylindrical samples. Afterwards, the molds were placed in a pressurized chamber and cured for 6 days at 100° C. and 17.23 MPa of pressure. Ramp time for 25° C. to 100° C. was 60 minutes. After the initial curing the samples were left to cool-down to room temperature over a period of one day. From the prepared cylinders, at least three sections from top to bottom (h=50.8 mm, φ=25.4 mm) were obtained. The first layer (+/−5 mm) at the top and the last at the bottom were discarded. The cylindrical samples were used for tri-axial stress-strain test to determine compressive strength, Young's modulus and Poisson ratios.

First, a low confined test (0.3 MPa) was performed to determine the compressive strength of each cement blend. For that purpose, the samples were located between two steel end-caps containing holes for pore pressure drainage to atmospheric conditions. The cylinders were jacketed in a thermal-shrinking plastic membrane. Axial deformations (strain) were determined from the average of two linear variable differential transducers (LVDT) and radial deformation from one radial chain-type single LDVT. A 0.5 MPa seating load was applied to the sample and the confining pressure was set to 0.3 MPa. After stabilization all LVDT were set to 0.000 mm. Load was then increased and applied at a constant rate of 0.5% strain per hour until failure, with the objective of estimating the effective confined compressive strength (ECS).

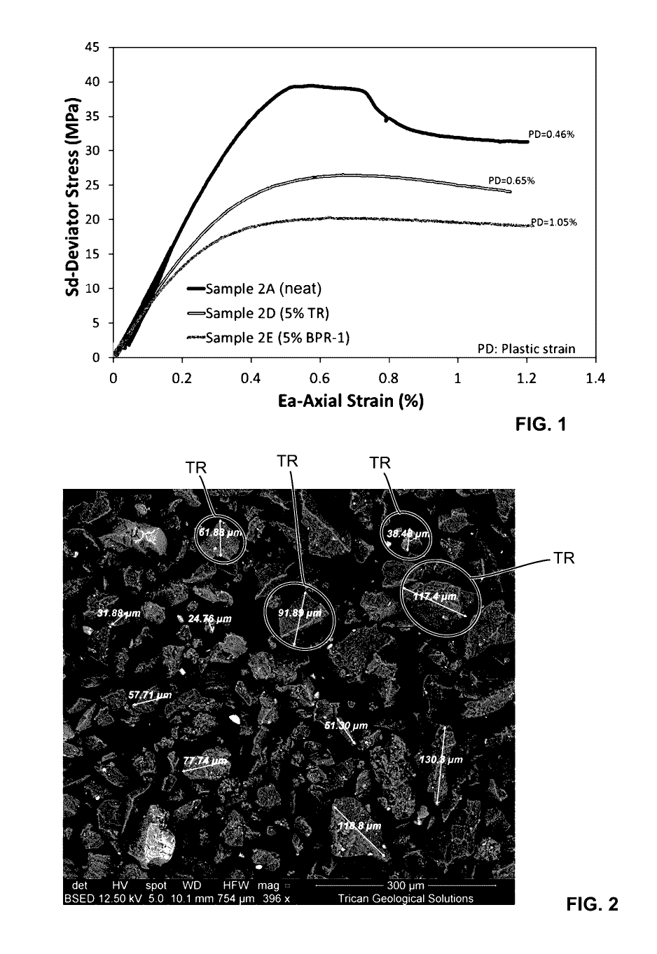

Knowing the ECS, at least two new confined tests were performed on the remaining cylindrical samples. For these extra tests the same procedure as described above was applied but this time the confining pressure applied was 2.5 MPa. Again, after stabilization all LVDT were set to 0.000 mm. Load was then increased, and applied at a constant rate of 1% strain per hour to a maximum axial stress of 50% of the expected ECS and then back down to a minimum deviator stress of 0.5 MPa. Afterwards the sample was loaded again at a constant rate of 1% strain per hour until peak failure (UCS) and, when possible, beyond this to determine if there was any residual strength value after failure (FIG. 1). The strain rate was chosen to allow test to be performed in a reasonable time frame while providing quasi-drained conditions. The maximum load of 50% of the ECS was chosen to ensure the cement blends stayed within the linear elastic range. Finally, from the resulting stress-strain curves (deviator stress vs axial strain) Young's modulus and Poisson ratios was calculated by linear fit to the points between 15% and 40% of the resulted UCS according to the recommendations of the draft API Technical report 10TR7. The results of the analysis are shown in Table 8.

TABLE 8
Tensile strength Testing Results

| | | | Yield | Yield | Failure | | Young's | | |
|---|---|---|---|---|---|---|---|---|---|
| | Additive | % | stress | strain | strain | UCS | Modulus | Poisson | |
| Slurry | type | bwoc | (GPa) | (%) | (%) | (GPa) | (GPa) | ratio | CS/TS |
| 2A | — | — | 26.89 | 0.27 | 0.55 | 40.29 | 12.77 | 0.23 | 11.5 |
| 2B | TR | 2 | 22.06 | 0.21 | 0.62 | 38.47 | 11.13 | 0.25 | 10.4 |
| 2C | BPR-1 | 2 | 13.34 | 0.14 | 0.54 | 29.86 | 10.77 | 0.23 | 8.3 |
| 2D | TR | 5 | 14.69 | 0.20 | 0.66 | 25.09 | 8.42 | 0.22 | 8.1 |
| 2E | BPR-1 | 5 | 8.52 | 0.11 | 0.62 | 20.21 | 7.02 | 0.23 | 6.6 |
| 1E | BPR-2 | 5 | 15.06 | 0.24 | 0.73 | 25.02 | 8.08 | 0.09 | 9.9 |
| 1G | BPR-3 | 5 | 18.87 | 0.30 | 0.66 | 28.37 | 6.14 | 0.08 | 10.5 |

The lower the Young's Modulus and the higher the failure strain, the more flexible the cement is, i.e., the more it can yield without fracturing. However, it is important not only to decrease the Young modulus but also to have a high compressive strength and enough tensile strength (CS/TS lower). The results in Table 8 show that cement blends containing BPR additives exhibit a sufficiently low Young's Modulus while still maintaining good compressive and tensile strengths. It is clear from the data in Table 8 that the blends containing BPR-1 have the lowest compressive to tensile strength ratio compared to cement alone or the cement and TR blend.

### Example 7

### Particle Shape and Microstructural Analysis

Samples of BPR and TR additives were placed in a FEI Quanta 250 Scanning Electron Microscope (SEM), manufactured by FEI of Eindhoven, the Netherlands, for morphological analysis. Specimens were mounted on aluminum stubs for imaging, with the SEM operating at low vacuum mode, 15 kV accelerating voltage and at an approximately 10 mm working distance.

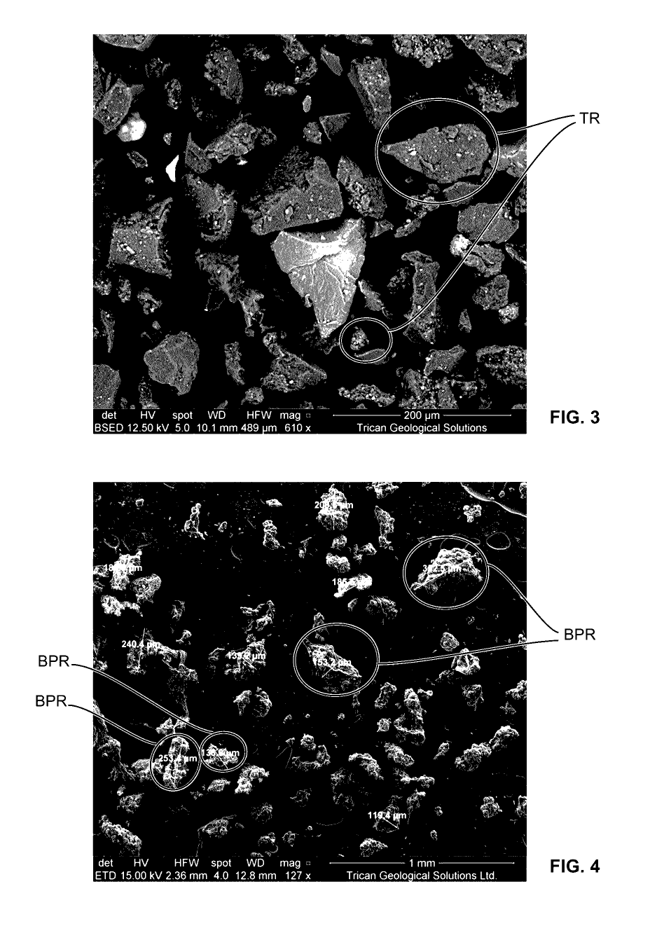

FIGS. 2 and 3 are magnified images of the surface of several TR particles. As shown, the TR particles are composed of many individual angular particles with different sizes. Referring to the scale legend in the lower, right corner of FIG. 2, it can be seen that the lengths of the fibers are from about 130 microns to less than about 20 microns.

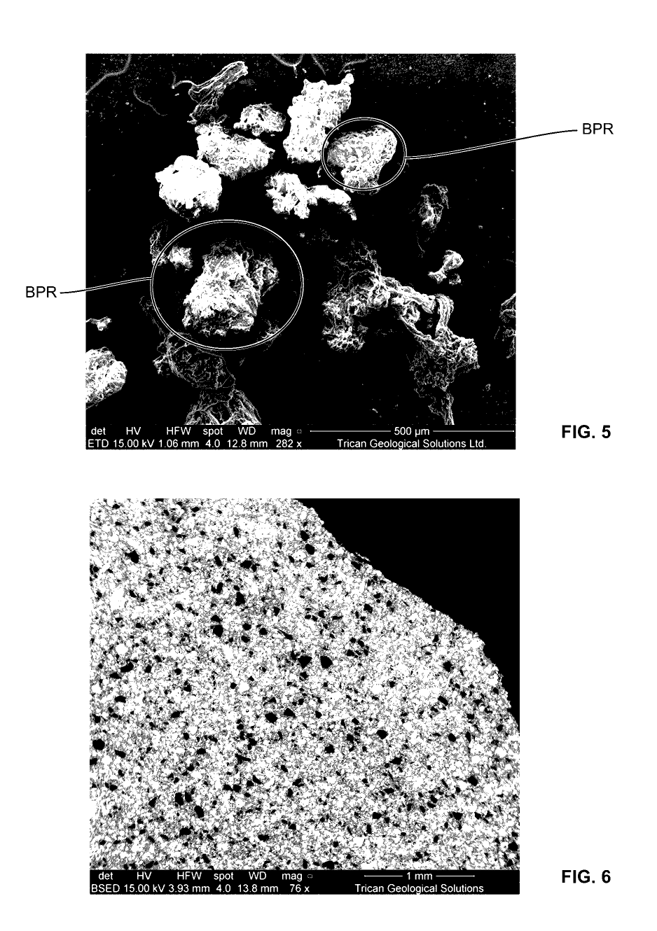

FIGS. 4 and 5 are magnified images of the surface of several BPR-1 particles. As shown, the BPR-1 particles are composed of many individual, irregular, and in some cases elongate, particles with different sizes. Referring to the scale legend in the lower, right corner of FIG. 4, it can be seen that the lengths of the fibers are from about 500 microns to less than about 100 microns. An irregular shape is favored for better bonding, less porous and improved interphase properties between the reinforcement polymeric elastomeric resins and the cement matrix. In contrast, angular particles with flat surface in general are weak points that produce lower tensile strength on hardened cement samples.

Additional microstructural analysis was performed in samples containing TR and BPR particles. Fragments of each hardened cement sample were dried in a vacuum convection oven at 50 ° C. for 48 hours to ensure all remaining water was removed. Afterwards, the samples were imbibed with a low viscosity resin under vacuum, leaving it to cure for 24 hours until hardened. Once cured the samples were polished with diamond paste until a specular surface was obtained. Before the SEM analysis the samples were Gold-coated and mounted on aluminum stubs for imaging, with the SEM operating at low vacuum mode, 15 kV accelerating voltage and at an approximately 10 mm working distance.

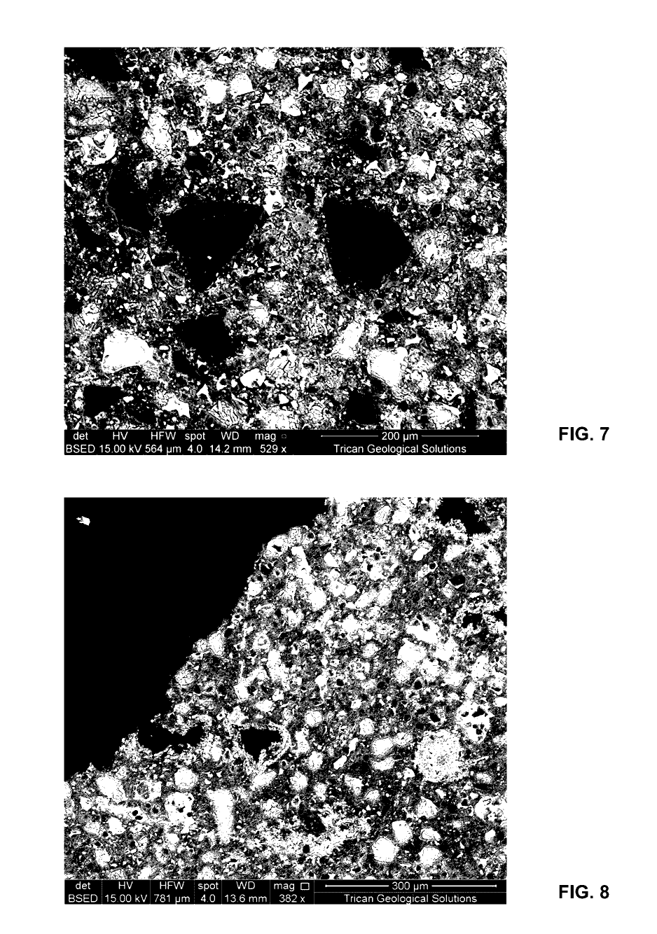

FIGS. 6 and 7 are magnified images of the polished surface of cement blend 2D, which is a sample containing TR particles. As shown, the TR particles are well distributed and their angular shape characteristic is easily appreciated. In addition, FIG. 7 shows that the interphase or interparticle transition zone (ITZ) is not smooth, indicating poor bonding between the rubber particles and the cement matrix, characterized by a separation between the surfaces of the TR particle and the cement. This type of ITZ is typically found in cements having inert reinforcement materials or fillers.

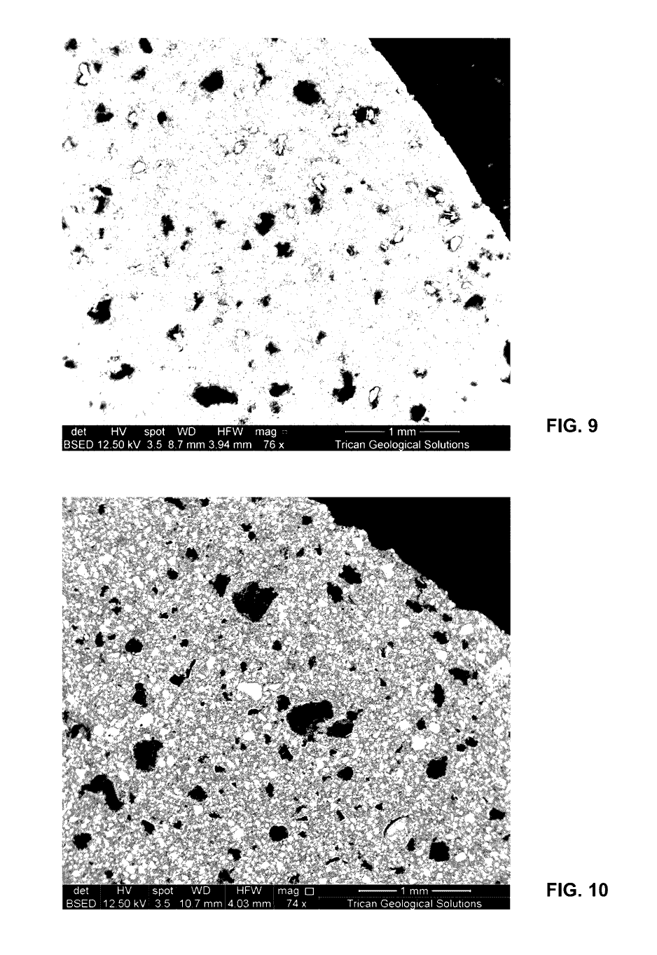

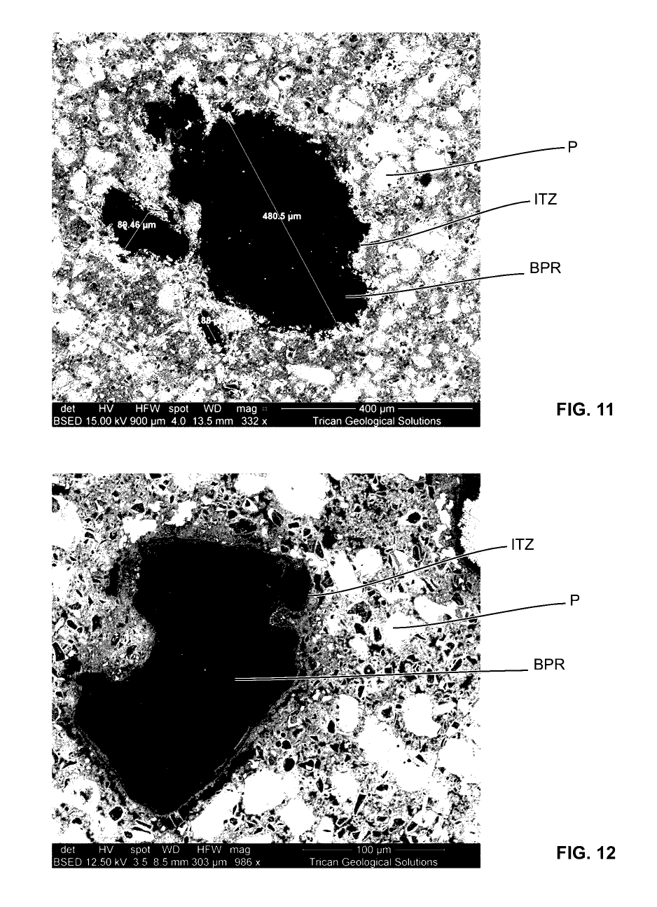

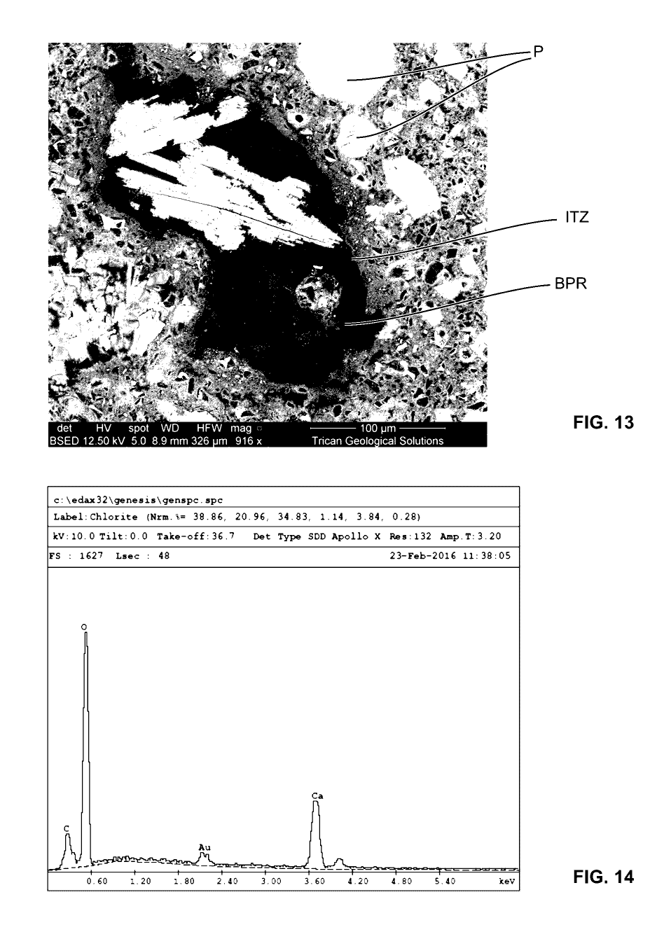

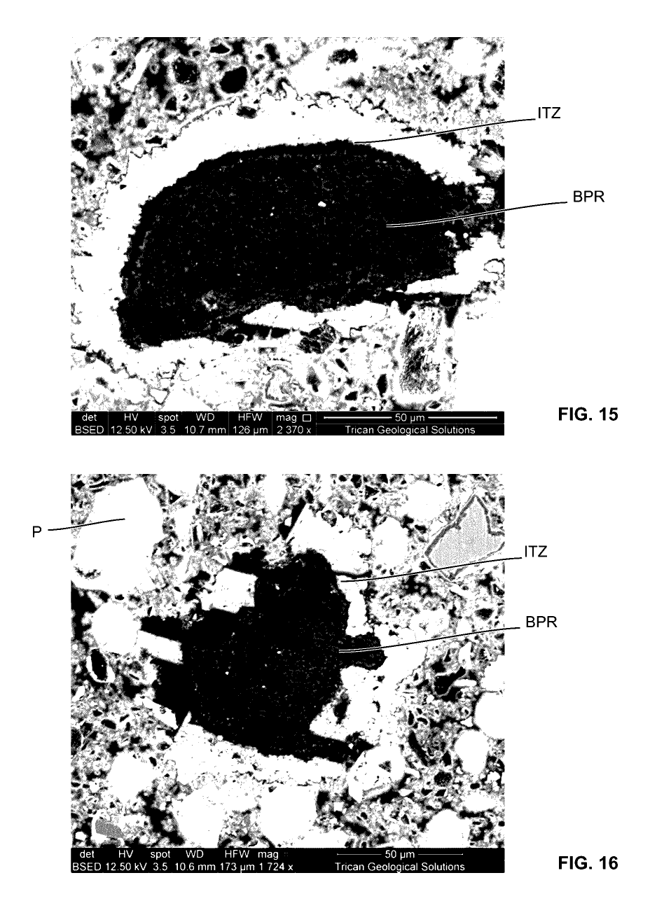

FIGS. 8 to 10 are magnified images showing the particle distribution and morphologies of the cement matrixes of blends 2E (5% BPR-1), 1 E (5% BPR-2) and 1G (5% BPR-3), respectively. As shown in these figures and also shown in FIGS. 11 and 12, it is evident that the irregular shape and possibly the reactivity of the BPR additives improved the ITZ area (FIGS. 11 and 12). This may have translated into better bonding, resulting in a blend with lower Young Modulus but good tensile strength. In almost all samples having BPR, a reaction ring (FIG. 11) and large precipitates between the bio-elastomeric particles was noticed (FIGS. 13, 15 and 16). These precipitates had a high intensity of Ca, C and O, when analyzed with an EDS detector (FIG. 14), which suggested they were composed of partially carbonated calcium hydroxides of different nature (globular and hexagonal plates). Despite the presence of precipitates in the ITZ, these appear more compacted and densified, which also suggests that less porous and more compacted C-S-H gels are formed due to the partial dissolution of the bio-elastomeric resin during cement curing.

Although embodiments have been described above with reference to the accompanying drawings, those of skill in the art will appreciate that variations and modifications may be made without departing from the scope thereof as defined by the appended claims.

What is claimed is:

1. A mixture for cementing a wellbore, the mixture comprising:
cement; and
a biodegradable polymeric elastomeric resin (BPR) having a significantly lower elastic modulus than that of set cement.

2. The mixture of claim 1 wherein the BPR comprises:
a starch component,
a thermoplastic resin component; and
a protein component; wherein the starch component, the thermoplastic resin component and the protein component are melted and mixed together to form the BPR.

3. The mixture of claim 1 wherein the BPR comprises:
about 20 wt. % (weight percentage) to about 60 wt. % of the starch component;
about 40 wt. % to about 80 wt. % of the thermoplastic resin component;
about 0.5 wt. % to about 2 wt. % of the protein component; and
0 to about 30 wt. % of a plasticizer/dispersant component.

4. The mixture of claim 3 wherein the starch component, the thermoplastic resin component, the protein component and the plasticizer/dispersant component are melted and mixed together to form the BPR.

5. The mixture of claim 3 wherein the plasticizer/dispersant component is a citric acid ester.

6. The mixture of claim 3 wherein the plasticizer/dispersant component is a non-citric acid based dispersant.

7. The mixture of claim 1 wherein the thermoplastic resin component is a polyester polyurethane resin, a polyester polyamide resin, or a polyether polyester resin.

8. The mixture of claim 1 wherein the protein component is albumin.

9. The mixture of claim 1 wherein the mixture comprises about 1% by weight of cement (bwoc) to about 10% bwoc BPR.

10. The mixture of claim 1 wherein the mixture comprises about 5% bwoc BPR.

11. A method for forming a wellbore cementing composition comprising:
combining water, cement and a biodegradable polymeric elastomeric resin (BPR) having a significantly lower elastic modulus than that of set cement.

12. The method of claim 11 wherein the BPR comprises:
a starch component,
a thermoplastic resin component;
and a protein component; wherein the starch component, the thermoplastic resin component and the protein component are melted and mixed together to form the BPR.

13. The method of claim 11 wherein the BPR comprises:
about 20 wt. % to about 60 wt. % of the starch component;
about 40 wt. % to about 80 wt. % of the thermoplastic resin component;
about 0.5 wt. % to about 2 wt. % of the protein component; and
0 to about 30 wt. % of a plasticizer/dispersant component.

14. The method of claim 11 wherein said combining cement, water and the BPR comprises:
combining cement, water and about 1% bwoc to about 10% bwoc BPR.

15. The method of claim 11 wherein said combining cement, water and the BPR comprises:
combining cement, water and about 3% bwoc to about 7% bwoc BPR.

16. The method of claim 11 wherein said combining cement, water and the BPR comprises:
combining cement, water and about 5% bwoc BPR.

17. The method of claim 11 wherein said combining cement, water and the BPR comprises:
mixing the cement and the BPR to form a first mixture; and
mixing the first mixture with the water.

18. A method for cementing a wellbore comprising:
combining water, cement and a biodegradable polymeric elastomeric resin (BPR) having a significantly lower elastic modulus than that of set cement; and
injecting the cement slurry into the wellbore.

19. The method of claim 18 wherein the BPR comprises:
a starch component,
a thermoplastic resin component;
and a protein component; wherein the starch component, the thermoplastic resin component and the protein component are melted and mixed together to form the BPR.

20. The method of claim 18 wherein said combining cement, water and the BPR comprises:
combining cement, water and about 5% bwoc BPR.
